(19) United States
(12) Patent Application Publication
(10) Pub. No.: US 2011/0001863 A1
(43) Pub. Date: Jan. 6, 2011

(54) DISPLAY WITH VIDEO CAMERA

(75) Inventor: HAI-LI WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/508,592

(22) Filed: Jul. 24, 2009

(30) Foreign Application Priority Data
Jul. 2, 2009 (CN) 200910303948.3

(51) Int. Cl. H04N 5/222

(52) U.S. Cl. 348/333.01; 348/E05.022

(57) ABSTRACT

A display for a computer includes a video camera with a peripheral equipment interface (PEI) disposed at a frame of the display. The PEI includes four signal pins connected to four idle pins of a plurality of idle pins of a first video connector of the display matching with a second video connector of a motherboard of the computer. A power circuit provides power to the PEI, to communicate the video camera with the motherboard via the first video connector and the second video connector.

### BACKGROUND

1. Technical Field

The present disclosure relates to displays, and particularly to a display with a video camera.

2. Description of Related Art

Nowadays, computers with displays are widely used. The displays ordinarily only have the single function of being a display for the computers. When a user would like to capture videos, for example, of themselves for video chat, they usually have to buy a camera and install it. However, it is not convenient to install the camera on the computer.

### BRIEF DESCRIPTION OF THE DRAWINGS

FIG. 1 is a schematic view of an exemplary embodiment of a computer display with a video camera.

FIG. 2 is a schematic circuit diagram of a first exemplary embodiment of the display with the video camera and a motherboard of the computer of FIG. 1.

FIG. 3 is a schematic circuit diagram of a second exemplary embodiment of a display with a video camera and the motherboard of FIG. 1.

### DETAILED DESCRIPTION

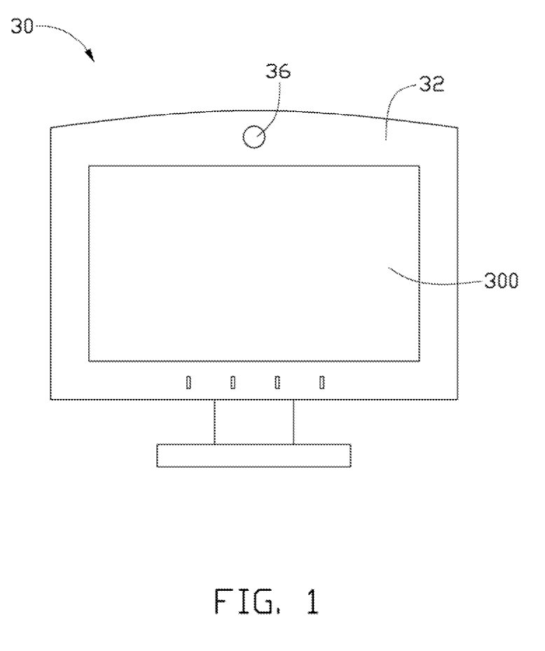

Referring to FIG. 1, an exemplary embodiment of a display 30 of a desktop computer 1 includes a frame 32, a display screen 300 such as a liquid crystal display mounted to the frame 32, and a video camera 36 disposed at the frame 32 above the display screen 300. In other embodiments, the video camera 36 can be disposed at other positions on the frame 32.

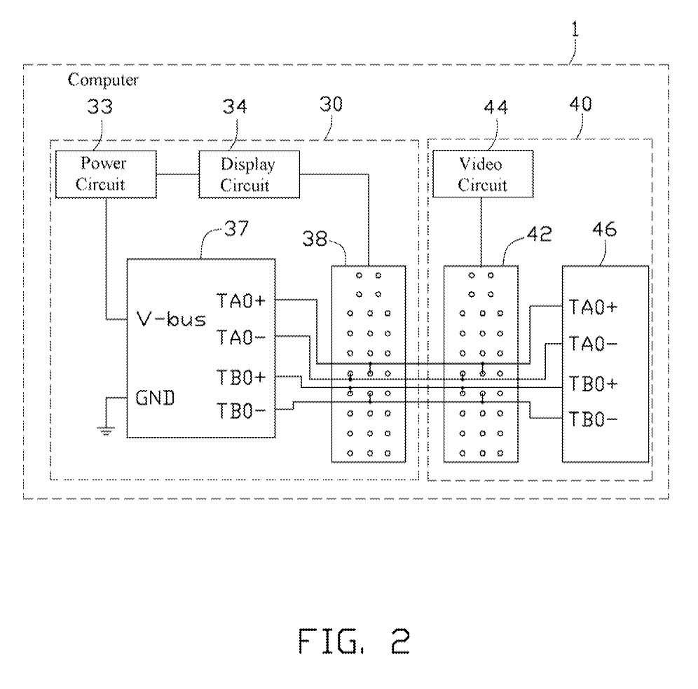

Referring to FIG. 2, the display 30 further includes a power circuit 33, a display circuit 34, and a video connector 38 such as a digital visual interface, a video graphics array connector, or a high definition multimedia interface. The power circuit 33 and the display circuit 34 are arranged on a circuit board (not shown) in the display 30. The video camera 36 includes a peripheral equipment interface (PEI) such as an Institute for Electrical and Electronic Engineers (IEEE) 1394 interface 37. The IEEE 1394 interface 37 includes four signal pins TA0+, TA0−, TB0+, and TB0−, a power signal pin V-bus, and a ground signal pin GND. The video connector 38 includes a plurality of video pins and six first idle pins. The four signal pins TA0+, TA0−, TB0+, and TB0− of the IEEE 1394 interface 37 are connected to four idle pins of six first idle pins of the video connector 38, to connect the video camera 36 to the video connector 38. The ground signal pin GND of the IEEE 1394 interface 37 is grounded. The power circuit 33 is connected to the power signal pin V-bus of the IEEE 1394 interface 37 to supply power to the IEEE 1394 interface 37, and connected to the display circuit 34 to supply power to the display circuit 34. The display circuit 34 is connected to the plurality of video pins of the video connector 38.

An exemplary embodiment of a motherboard 40 of the computer 1 includes a video connector 42 such as a digital visual interface, a video graphics array connector, or a high definition multimedia interface, a video circuit 44, and a south bridge chip 46. The video connector 42 includes a plurality of video pins corresponding to the plurality of video pins of the video connector 38 and six second idle pins corresponding to the six first idle pins of the video connector 38. The south bridge chip 46 includes an IEEE 1394 controller. The IEEE 1394 controller includes four signal pins TA0+, TA0−, TB0+, and TB0−. The four signal pins TA0+, TA0−, TB0+, and TB0− of the IEEE 1394 controller are connected to four second idle pins of the six second idle pins of the video connector 42. The plurality of video pins of the video connector 42 is connected to the video circuit 44.

In use, the video connector 38 is electrically engaged with the video connector 42 and the four first idle pins of the video connector 38 are connected to the four second idle pins of the video connector 42. Therefore, the four signal pins TA0+, TA0−, TB0+, and TB0− of the IEEE 1394 interface 37 are correspondingly connected to the four signal pins TA0+, TA0−, TB0+, and TB0− of the IEEE 1394 controller. The plurality of video pins of the video connector 38 is connected to the plurality of video pins of the video connector 42. The power circuit 33 converts alternating current (AC) to 12V direct current (DC) to provide power to the display circuit 34 and the power signal pin V-bus of the IEEE 1394 interface 37 to power the video camera 36. Therefore the video camera 36 is capable of communicating with the motherboard 40 via the IEEE 1394 interface 37, the video connector 38, and the video connector 42.

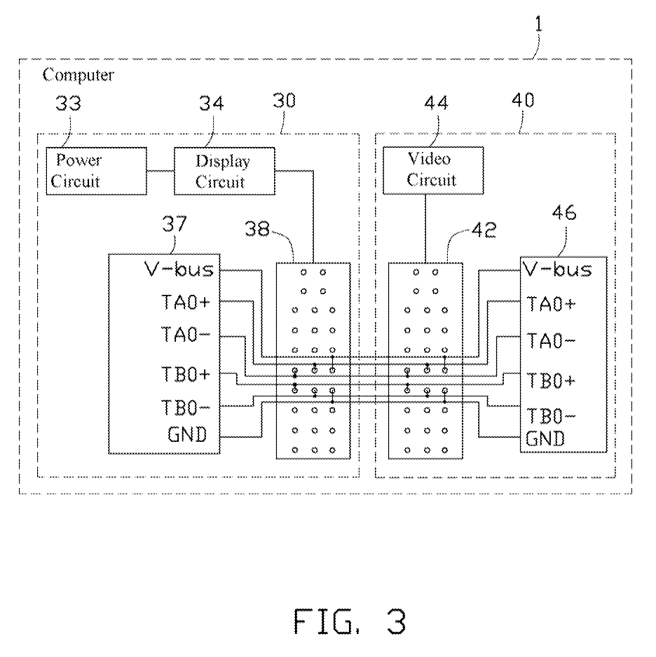

FIG. 3 illustrates a second exemplary embodiment of a display 30 and the motherboard 40. The power circuit 33, the display circuit 34, the video connector 38 of the display 30, the video connector 42, and the video circuit 44 are the same as those of the first embodiment. The differences between the first and second embodiments are that in the second embodiment, the power signal pin V-bus of the IEEE 1394 interface 37 is not connected to the power circuit 33 but connected instead to one idle pin of a fifth first idle pin of the video connector 38. The ground signal pin GND of the IEEE 1394 interface 37 is not grounded but instead connected to a sixth first idle pin of the video connector 38. The IEEE 1394 controller further includes a power signal pin V-bus and a ground signal pin GND. The power signal pin V-bus of the IEEE 1394 controller is connected to a fifth second idle pin of the video connector 42 corresponding to the idle pin connected to the power signal pin V-bus of the IEEE 1394 interface 37. The ground signal pin GND of the IEEE 1394 controller is connected to a sixth second idle pin of the video connector 42 corresponding to the idle pin connected to the ground signal pin GND of the IEEE 1394 interface 37.

In use, the video connector 38 is electrically engaged with the video connector 42, the six first idle pins of the video connector 38 are connected to the corresponding six second idle pins of the video connector 42. Therefore, the four signal pins TA0+, TA0−, TB0+, and TB0−, the power signal pin V-bus, and the ground pin GND of the IEEE 1394 interface 17 are correspondingly connected to the four signal pins TA0+, TA0−, TB0+, and TB0−, the power signal pin V-bus, and the ground pin GND of the IEEE 1394 controller. The plurality of video pins of the video connector 38 is connected to the plurality of video pins of the video connector 42. The power circuit 33 converts AC power into 12V DC power to provide to the display circuit 34. The IEEE 1394 controller provides power from a power supply (not shown) of the computer 1 for the video camera 36 via the video connector 42, the video connector 38, and the IEEE 1394 interface 37. Therefore the video camera 36 is capable of communicating with the motherboard 40 via the IEEE 1394 interface 37, the video connector 38, and the video connector 42.

In other embodiments, the video camera 36 can be connected to the motherboard 40 via other interfaces such as universal serial bus interfaces.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A display for a desktop computer, comprising:
a frame;
a video camera with a peripheral equipment interface (PEI) disposed at the frame, the PEI comprising four signal pins;
a display circuit to control display of the display;
a power circuit to provide power to the display circuit and the PEI; and
a first video connector to mate with a second video connector of a motherboard of the computer, the first video connector of the display comprising:
a plurality of video pins connected to the display circuit; and
a plurality of idle pins connected to idle pins of the second video connector of the motherboard;
wherein the four signal pins of the PEI are connected to four idle pins of the plurality of idle pins of the first video connector.

2. The display of claim 1, wherein the PEI is an Institute for Electrical and Electronic Engineers (IEEE) 1394 interface.

3. The display of claim 1, wherein the first video connector is a video graphics array connector.

4. The display of claim 1, wherein the first video connector is a digital visual interface connector.

5. A display for a desktop computer, comprising:
a frame;
a video camera with a peripheral equipment interface (PEI) disposed at the frame, the PEI comprising four signal pins, a power signal pin, and a ground signal pin;
a display circuit to control display of the display;
a power circuit to provide power to the display circuit; and
a first video connector to mate with a second video connector of a motherboard of the computer, the first video connector comprising:
a plurality of video pins connected to the display circuit and a plurality of video pins of the second video connector; and
a plurality of idle pins connected to idle pins of the second video connector of the motherboard;
wherein the four signal pins, the power signal pin, and the ground signal pin of the PEI are connected to six idle pins of the plurality of idle pins of first the video connector.

6. The display of claim 5, wherein the PEI is an Institute for Electrical and Electronic Engineers (IEEE) 1394 interface.

7. The display of claim 5, wherein the first video connector is a digital visual interface.

8. A display system comprising:
a display comprising:
a frame;
a video camera with a peripheral equipment interface (PEI) disposed at the frame, the PEI comprising four signal pins;
a display circuit to control display of the display;
a power circuit to provide power to the display circuit; and
a first video connector comprising a plurality of first video pins connected to the display circuit, and a plurality of first idle pins, four first idle pins of the plurality of first idle pins connected to the four signal pins; and a motherboard comprising:
a video circuit for providing video signals to the display;
a second video connector mating with the first video connector of the display, the second video connector comprising a plurality of second video pins connected to the video circuit and the first video pins of first the video connector of the display, and a plurality of second idle pins connected to the first idle pins of the first video connector of the display; and
a motherboard chip connected the corresponding second idle pins of the second video connector of the motherboard, to communicate the video camera with the motherboard.

9. The display system of claim 8, wherein the PEI is an Institute for Electrical and Electronic Engineers (IEEE) 1394 interface.

10. The display system of claim 8, wherein the PEI further comprises a power signal pin and a ground signal pin, the power signal pin and the ground signal pin are connected to corresponding pins of the power circuit.

11. The display system of claim 10, wherein the motherboard chip comprises four signal pins connected to the four second idle pins of the plurality of second idle pins, corresponding to the four signal pins of the PEI.

12. The display system of claim 10, wherein the first video connector of the display is a video graphics array, the second video connector of the motherboard is a video graphics array connector.

13. The display system of claim 8, wherein the PEI further comprises a power signal pin and a ground signal pin, the power signal pin and the ground signal pin are connected to two first idle pins of the plurality of first idle pins of the first video connector of the display, the motherboard chip comprises a power signal pin and a ground signal pin, the power signal pin and the ground signal pin of the motherboard are connected to two second idle pins of the plurality of second idle pins of the second video connector of the motherboard.

14. The display system of claim 13, wherein the first video connector of the display is a digital visual interface, the second video connector of the motherboard is a digital visual interface.
